(19) United States
(12) Patent Application Publication
(10) Pub. No.: US 2016/0264774 A1
(43) Pub. Date: Sep. 15, 2016

(54) THERMOPLASTIC MOULDING COMPOUNDS

(71) Applicant: LANXESS Deutschland GmbH, Cologne (DE)

(72) Inventors: Matthias BIENMUELLER, Krefeld (DE); Wolfgang WAMBACH, Cologne (DE); Jochen ENDTNER, Cologne (DE)

(21) Appl. No.: 15/062,252

(22) Filed: Mar. 7, 2016

(30) Foreign Application Priority Data
Mar. 9, 2015 (EP) 15158161.8

(51) Int. Cl. C08L 67/02; C08K 5/5313; C08K 5/5357; C08K 7/14; C08K 3/30; C08K 5/11; C08K 3/32; C08K 5/3492

(52) U.S. Cl. CPC C08L 67/02; C08K 3/32; C08K 5/5313; C08K 5/34924; C08K 7/14; C08K 3/30; C08K 5/11; C08K 5/5357; C08K 2003/328; C08K 2003/3045

(57) ABSTRACT

The invention relates to compositions and also to thermoplastic moulding compounds which can be produced from these compositions, and to products based thereon in turn, comprising at least one polyalkylene terephthalate or polycycloalkylene terephthalate, at least one organic phosphinic salt and/or at least one organic diphosphinic salt and at least one inorganic phosphate salt.

### FIELD OF THE INVENTION

The invention relates to compositions and also to thermoplastic moulding compounds which can be produced from these compositions, and to products based thereon in turn, comprising at least one polyalkylene terephthalate or polycycloalkylene terephthalate, at least one organic phosphinic salt and/or at least one organic diphosphinic salt and at least one inorganic phosphate salt.

### BACKGROUND OF THE INVENTION

DE 101 96 299 T1 discloses flame-retardant resin compositions based inter alia on polyethylene terephthalate and polybutylene terephthalate (examples 28-30) that use as flame retardant aluminium methylethylphosphinate, in combination with melamine polyphosphate in example 29, and also, additionally, calcium hydrogen phosphate.

DE 11 2006 001 824 T5 describes flame-retardant resin compositions with halogen-containing flame retardants. Example 17 comprises PBT, PET, a bromine-containing flame retardant and calcium hydrogen phosphate as heat stabilizer.

WO 2012/139990 A1 discloses tracking-resistant, flame-retardant, reinforced thermoplastic moulding compounds based on polyalkylene terephthalates and comprising not only a flame retardant composed of nitrogen-containing or phosphorus-containing compounds but also a polyolefin from the group of polyethylene, polypropylene, and polypropylene copolymers. These moulding compounds are indeed notable for increased tracking resistance, albeit at the expense of mechanical properties such as the tensile strength, for example. The use of polyolefins as a polymer for addition harbours the risk, moreover, of inevitable detractions from the advantages typical of polyalkylene terephthalates, such as high surface tension and high colour stability under thermal load. A disadvantage of halogen-containing flame retardants is the possibility in the event of fire of increased formation of highly toxic dioxins and furans.

It was an object of the present invention, therefore, to provide flame-retardant polyalkylene terephthalate- or polycycloalkylene terephthalate-based thermoplastic moulding compounds having increased tracking resistance and preferably without halogen-containing flame retardants. It was a further object to not use polyolefins in the moulding compounds, while allowing the production therefrom of products which, by comparison with moulding compounds without enhanced tracking resistance, exhibit no loss in the mechanical properties, especially the strength, and which also exhibit no deterioration in fire performance.

### SUMMARY OF THE INVENTION

The achievement of the object and subject of the invention are compositions, and also thermoplastic moulding compounds which can be produced from them, comprising
A) at least one polyalkylene terephthalate or polycycloalkylene terephthalate,
B) at least one organic phosphinic salt of the formula (I) and/or at least one organic diphosphinic salt of the formula (II) and/or polymers thereof,

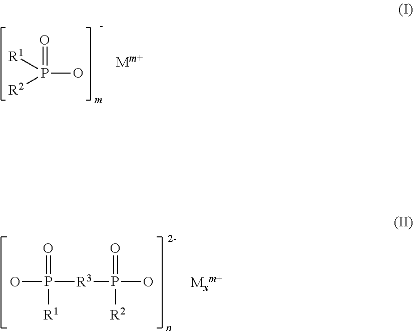

in which
R¹ and R² are identical or different and are a linear or branched C₁-C₆ alkyl, and/or are C₆-C₁₄ aryl,
   R³ is linear or branched C₁-C₁₀alkylene, C₅-C₁₀ arylene or C₁-C₅ alkyl-C₆-C₁₀ arylene or C₆-C₁₀ aryl-C₁-C₆ alkylene,
   M is aluminium, zinc or titanium,
   m is an integer of 1 to 4;
   n is an integer of 1 to 3, and
   x is 1 and 2,
   and n, x and m in formula (II) may at the same time adopt only those integers such that the diphosphinic salt of the formula (II) as a whole is uncharged, and
C) at least one inorganic phosphate salt from the group of metal hydrogen phosphates, metal dihydrogen phosphates, metal dihydrogen pyrophosphates and/or metal pyrophosphates, metal being sodium, potassium, magnesium, zinc, copper and/or aluminium.

Products based on the compositions of the invention surprisingly exhibit, even without the use of polyolefins, a tracking resistance which is at least at an equivalent level to that in the prior art, but exhibit no loss in terms of the mechanical parameters of flexural strength, outer fibre strain or IZOD impact strength.

Explanations

For clarification, it should be noted that, in the context of this invention, all definitions and parameters set out below, either general or stated within ranges of preference, are encompassed in any desired combinations, wherein ranges include endpoints listed, as well as any range that may extend from any number in a listed range to any other number in the listed range.

Moreover, for clarification, it should be noted that the flexural strength in technical mechanics is a value for a flexural strain in a component subject to flexure, which if exceeded is generally accompanied by fracture failure of the component. It describes the resistance that a workpiece offers to flexing or fracture thereof. In the ISO 178 accelerated flexural test, specimens in beam form, presently with dimensions of 80 mm·10 mm·4.0 mm at the ends, are placed on two supports and loaded in the centre with a flexural die (Bodo Cadrowitzr: Tabellarische Übersicht über die Prüfung von Kunststoffen, 6th Edition, Giesel-Verlag für Publizität, 1992, pp. 16-17).

According to “http://de.wikipedia.org/wiki/Biegeversuch”, the flexural modulus is determined in the three-point bending test, with a test specimen being positioned on two supports and loaded in the centre with a test die. For a flat sample, the flexural modulus is then calculated according to formula (III) as follows:

E=l_{V}³(X_{H}−X_{L})/4D_{L}ba³ (III)

where E flexural modulus in kN/mm²; l_{V}=span in mm; X_{H}=end of determination of flexural modulus in kN; X_{L}=beginning of determination of flexural modulus in kN; D_{L}=flexing in mm between X_{H} and X_{L}; b=sample width in mm; a=sample thickness in mm.

The impact resistance describes the capacity of a material to absorb impact energy and collision energy without undergoing fracture. Impact resistance is calculated as the ratio of impact energy and specimen cross section (unit of measurement: kJ/m²).

Impact resistance can be determined by various kinds of notched Impact flexural test (Charpy. Izod). In contrast to the notched impact resistance, there is no notching carried out in the case of the impact resistance of the test specimens. In the context of the present invention, the Izod impact resistance was determined in accordance with ISO 180-1U on freshly injection moulded test specimens with dimensions of 80 mm·10 mm·4 mm.

The tracking resistance characterizes the dielectric strength of the surface (track path) of insulating materials, especially on exposure to moisture and contaminants. It defines the maximum tracking current which can be brought about under standardized testing conditions (specified voltage, conductive layer material) in a defined test arrangement (electrode spacing, electrode form). The tracking resistance is reported using the CTI (Comparative Tracking Index). The CTI is the voltage up to which the base material exhibits no tracking on dropwise application of 50 drops of standardized electrolyte solutions (A or B giving KA or KB values). Measurement is carried out on the surface, with one drop falling between two platinum electrodes every 30 seconds. The criterion of failure is a tracking current of >0.5 A. Details on the measurement method for the CTI are stipulated in IEC 60112.

The melt volume-flow rate (MVR, formerly and often even now in the jargon Melt Volume Rate or MVI for Melt Volume Index) is used to characterize the flow behaviour (moulding composition testing) of a thermoplastic under defined pressure and temperature conditions. The melt mass-flow rate is determined as for the melt volume-flow rate, and the result of the measurement is different by the melt density. The MVR is a measure of the viscosity of a polymeric melt. From the MVR it is possible to conclude the degree of polymerization, this being the average number of monomer units in one molecule.

The MVR is determined according to ISO 1133, in the context of the present invention, by means of a capillary rheometer, with the material (pellets or powder) being melted in a heatable cylinder and pressed, under a pressure resulting from the applied load, through a defined nozzle (capillary). A determination is made of the emerging volume or mass, respectively, of the polymer melt (referred to as the extrudate) as a function of time. A key advantage of the melt volume-flow rate lies in the simplicity of measuring the piston travel for a known piston diameter in order to determine the volume of melt that has emerged. The relevant equation is as follows: MVR=volume/10 min. The unit for MVR is cm³/10 min.

“Alkyl” in the context of the present invention identifies a straight-chain or branched, saturated hydrocarbon group. In certain embodiments, an alkyl group having 1 to 6 carbon atoms is used. It can then be referred to as a “lower alkyl group”. Preferred alkyl groups are methyl (Me), ethyl (Et), propyl, more particularly n-propyl and isopropyl, butyl, more particularly n-butyl, isobutyl, sec-butyl, tert-butyl, pentyl groups, more particularly n-pentyl, isopentyl, neopentyl, hexyl groups and the like. Similar comments apply in respect of the term “polyalkylene”.

“Aryl” in the context of the present invention denotes a monocyclic aromatic hydrocarbon ring system or a polycyclic ring system in which two or more aromatic hydrocarbon rings are fused, or at least one aromatic monocyclic hydrocarbon ring which is fused with one or more cycloalkyl and/or cycloheteroalkyl rings. In embodiments according to the invention, aryl or arylene is an aryl group having 6 to 14 carbon atoms. Preferred aryl groups having an aromatic carbocyclic ring system are phenyl, 1-naphthyl (bicyclic), 2-naphthyl (bicyclic), anthracenyl (tricyclic), phenanthrenyl (tricyclic), pentacenyl (pentacyclic) and similar groups. Other preferred aryl groups are benzodioxanyl, benzodioxolyl, chromanyl, indolinyl groups and the like. In certain embodiments, aryl groups, as described herein, may be substituted. In certain embodiments, an aryl group may have one or more substituents.

“Alkylaryl” in the sense of the present invention denotes an alkyl-aryl group, the alkylaryl group being bonded covalently through the alkyl group to the defined chemical structure. One alkylaryl group preferred in accordance with the invention is the benzyl group (—CH₂C₆H₅). Alkylaryl groups according to the present invention may alternatively be substituted, meaning that either the aryl group and/or the alkyl group may be substituted. In contrast to this, “arylalkyl” in the sense of the present invention denotes an aryl-alkyl group where the arylalkyl group is bonded covalently through the aryl group to the defined chemical structure.

The standards cited in this specification are applicated in their version at the filing date of the present patent application.

### PREFERRED EMBODIMENTS OF THE INVENTION

Component A)

The polyalkylene terephthalates or polycycloalkylene terephthalates for use as component A) in accordance with the invention may be prepared by various methods, may be synthesized from a variety of building blocks, and, in a specific application scenario, may be equipped, alone or in combination, with processing aids, stabilizers, polymeric alloying co-components (e.g. elastomers) or else reinforcing materials (such as mineral fillers or glass fibres, for example) and optionally further additives, to give materials having tailored combinations of properties. Also suitable are blends with fractions of other polymers, in which case it may be possible optionally for one or more compatibilizers to be employed. The properties of the polymers may be improved as and when needed by addition of elastomers.

Preferred polyalkylene terephthalates or polycycloalkylene terephthalates can be prepared from terephthalic acid (or reactive derivatives thereof) and aliphatic or cycloaliphatic diols having 2 to 10 C atoms by known methods (Kunststoff-Handbuch, vol. VIII, pp. 695 ff, Karl Hanser Verlag, Munich 1973).

Preferred polyalkylene terephthalates or polycycloalkylene terephthalates comprise at least 80 mol %, preferably at least 90 mol %, based on the dicarboxylic acid, of terephthalic acid radicals and at least 80 mol %, preferably at least 90 mol %, based on the diol component, of 1,4-cyclohexanedimethanol and/or ethylene glycol and/or propane-1,3-diol (in the case of polypropylene terephthalate) and/or butane-1,4-diol radicals.

Preferred polyalkylene terephthalates or polycycloalkylene terephthalates may as well as terephthalic acid radicals include up to 20 mol % of radicals of other aromatic dicarboxylic acids having 8 to 14 C atoms or radicals of aliphatic dicarboxylic acids having 4 to 12 C atoms, more particularly radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid.

Preferred polyalkylene terephthalates or polycycloalkylene terephthalates may as well as 1,4-cyclohexanedimethanol and/or ethylene glycol and/or 1,3-propanediol and/or 1,4-butanediol include up to 20 mol % of other aliphatic diols having 3 to 12 C atoms or up to 20 mol % of cycloaliphatic diols having 6 to 21 C atoms, preferably radicals of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(8-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

Particularly preferred are polyalkylene terephthalates or polycycloalkylene terephthalates prepared solely from terephthalic acid and reactive derivatives thereof, especially dialkyl esters thereof, and 1,4-cyclohexanedimethanol and/or ethylene glycol and/or 1,3-propanediol and/or 1,4-butanediol, especially preferably poly-1,4-cyclohexanedimethanol terephthalate, polyethylene terephthalate and polybutylene terephthalate and mixtures thereof.

Preferred polyalkylene terephthalates or polycycloalkylene terephthalates are also copolyesters prepared from at least two of the abovementioned acid components and/or from at least two of the abovementioned alcohol components. Particularly preferred copolyesters are poly(ethylene glycol/butane-1,4-diol) terephthalates.

The polyalkylene terephthalates or polycycloalkylene terephthalates generally possess an intrinsic viscosity of about 30 to about 150 cm³/g, preferably of about 40 to about 130 cm³/g, more preferably of about 50 to about 100 cm³/g, measured in each case in phenol/o-dichlorobenzene (1:1 part by weight) at 25° C. The intrinsic viscosity IV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from measurement series or through the use of suitable approximation methods (e.g. Billmeyer). The VN [ml/g] is obtained from the measurement of the solution viscosity in a capillary viscometer, an Ubbelohde viscometer, for example. The solution viscosity is a measure of the average molecular weight of a polymer. Determination is made on dissolved polymer, with various solvents (formic acid, m-cresol, tetrachloroethane, phenol, 1,2-dichlorobenzene, etc.) and concentrations being used. Through the viscosity number VN it is possible to monitor the processing and service properties of polymers. A thermal load on the polymer, ageing processes or exposure to chemicals, weathering and light can be investigated by means of comparative measurements. The process is standardized for common polymers: in the context of the present invention, according to DIN ISO 1628-5 for polyesters. In this regard, see also: http://de.wikipedia.org/wiki/Viskosimetrie and “http://de.wikipedia.org/wiki/Mark-Houwink-Geichung”.

The polyalkylene terephthalates or polycycloalkylene terephthalates for use as component A) in accordance with the invention may also be used in a mixture with other polyesters and/or further polymers.

Customary additives, especially mould release agents, may be admixed in the melt, during compounding, to the polyalkylene terephthalates or polycycloalkylene terephthalates to be used as component A).

The skilled person understands compounding (Compound=mixture) as a term from plastics technology which can be equated with plastics processing and which describes the upgrading process of plastics by admixing of adjuvants (fillers, additives and so on) for targeted optimization of the profiles of properties. Compounding takes place preferably in extruders, more preferably in co-rotating twin-screw extruders, counter-rotating twin-screw extruders, planetary roller extruders or co-kneaders, and encompasses the process operations of conveying, melting, dispersing, mixing, degassing and pressure build-up.

At least one polyalkylene terephthalate may be preferably used as component A) and may be selected from polyethylene terephthalate [CAS No. 25038-59-9] or polybutylene terephthalate [CAS No. 24968-12-5], especially polybutylene terephthalate (PBT).

An alternative for component A) is preferably poly-1,4-cyclohexanedimethanol terephthalate [CAS No. 25037-99-4] as polycycloalkylene terephthalate.

Component B)

The organic phosphinic salts for use in accordance with the invention as component B), of the formula (I) Indicated above, and/or organic diphosphinic salts of the formula (II) indicated above and/or polymers thereof are also referred to in the context of the present invention as phosphinates.

In the formulae (I) or (II), M is preferably aluminium. In the formulae (I) and (II), R¹ and R² are preferably identical or different and are C₁-C₆ alkyl, linear or branched, and/or phenyl. More preferably, R¹ and R² are identical or different and are methyl, ethyl, n-propyl, isopropyl, n-butyl, tert-butyl, n-pentyl and/or phenyl.

Preferably, R³ in formula (II) is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene. More preferably, R³ is phenylene or naphthylene. Suitable phosphinates are described in WO-A 97/39053, the content of which in relation to the phosphinates is encompassed by the present specification. Particularly preferred phosphinates in the sense of the present invention are aluminium salts and zinc salts of dimethylphosphinate, of ethylmethylphosphinate, of diethylphosphinate and of methyl-n-propylphosphonate and also mixtures thereof.

In formula (I), m is preferably 2 and 3, more preferably 3.

In formula (II), n is preferably 1 and 3, more preferably 3.

In formula (II), x is preferably 1 and 2, more preferably 2.

Aluminium tris(diethylphosphinate) [CAS No. 225789-38-8] may be used with very particular preference as component B), and is available, for example, from Clariant International Ltd. Muttenz, Switzerland under the trade name Exolit® OP1230 or Exolit® OP1240.

Component C)

Employed as component C) is at least one inorganic phosphate salt from the group of metal hydrogen phosphates, metal dihydrogen phosphates, metal dihydrogen pyrophosphates and/or metal pyrophosphates, metal in component C) being sodium, potassium, magnesium, zinc, copper and/or aluminium.

The inorganic phosphate salt for use in accordance with the invention as component C) includes the corresponding hydrates.

Preferred metals of component C) are sodium, potassium, magnesium, zinc, or aluminium. Particularly preferred metals are magnesium and/or zinc. Especially preferred as metal is zinc. Employed as component C) with preference are those inorganic phosphate salts which have a pH of about 2 to about 6, more preferably of about 2 to about 4, the figures for the pH being based here on aqueous medium at 20° C. at a concentration of 1 g per litre.

Employed with preference from the group of the metal dihydrogen pyrophosphates and metal pyrophosphates are sodium dihydrogen pyrophosphate [CAS No. 7758-16-9], magnesium pyrophosphate [CAS No. 13446-24-7] and zinc pyrophosphate [CAS No. 7446-26-6], with zinc pyrophosphate being particularly preferred. The latter is available, for example, under the name Z34-80 from Chemische Fabrik Budenheim KG, Budenheim, Germany.

From the group of the metal hydrogen phosphates, preference is given to using magnesium hydrogen phosphate [CAS No. 7757-86-0] and zinc hydrogen phosphate [CAS No. 7664-38-2].

From the group of metal dihydrogen phosphates for preferred use in particular as component C), preference is given to using aluminium dihydrogen phosphate [CAS No. 13530-50-2], magnesium bis(dihydrogen phosphates) [CAS No. 13092-66-5], zinc bis(dihydrogen phosphate) [CAS No. 13598-37-3] and zinc bis(dihydrogen phosphate) dihydrate [CAS No. 13986-21-5], with zinc bis(dihydrogen phosphate) and zinc bis(dihydrogen phosphate) dihydrate being very particularly preferred and zinc bis(dihydrogen phosphate) dihydrate being especially preferred. The latter is available, for example, under the name Z21-82 from Chemische Fabrik Budenheim KG, Budenheim, Germany.

The compounds of component C) can be used individually or as a mixture, optionally with addition of calcium pyrophosphate [CAS No. 7790-76-3] or calcium hydrogen phosphate.

The compositions of the invention and the moulding compounds to be produced from them preferably comprise component A) at about 68 to about 93.99 wt %, component B) at about 6 to about 30 wt % and component C) at about 0.01 to about 2 wt %, the sum of all the weight percentages always making 100.

With particular preference the compositions of the invention and the moulding compounds to be produced therefrom comprise components A) of about 79 to about 89.9 wt %, component B) of about 10 to about 20 wt % and component C) of about 0.1 to about 1 wt %, the sum of all the weight percentages always making 100.

The preparation of moulding compounds of the invention for further utilization takes place by mixing of the compositions of the invention in at least one mixer, preferably compounder. This gives, as intermediates, moulding compounds based on the compositions of the invention. These moulding compounds—also referred to as thermoplastic moulding compounds—may either consist exclusively of components A), B) and C), or else may comprise further components as well as components A), B) and C). In this case, within the quantitative ranges specified, components A), B) and C) can be varied such that the sum of all the weight percentages always makes 100.

In the case of thermoplastic moulding compounds and products to be produced therefrom, the fraction of the compositions of the invention in them is preferably about 40 to 100 wt %, with the remaining constituents constituting adjuvants, selected by the skilled person in accordance with the subsequent use of the products, preferably from at least one of components D) to F) defined below.

Component D)

In one preferred embodiment, in addition to components A), B) and C), at least one nitrogen-containing flame retardant component D) is used additionally, preferably about 0.1 to about 15 wt %, more preferably about 3 to about 10 wt %, and at least one of the components A), B) or C) is to be varied within the quantitative ranges specified in such a way that the sum of all the weight percentages of components A), B), C) and D), based on the moulding compound, is always 100.

Preferred nitrogen-containing flame retardants are those comprising melamine and/or condensation products with melamine, more particularly melem [CAS No. 1502-47-2], melam [CAS No. 3576-88-3] and melon [CAS No. 32518-77-7]. Particularly preferred among the nitrogen-containing flame retardants comprising melamine are reaction products of melamine with acids, very particular preference being given to melamine cyanurate, melamine polyphosphate and/or melamine-intercalated aluminium, zinc or magnesium salts of condensed phosphates, as described in WO2012/025362 A1. Especially preferred are melamine cyanurate, melamine polyphosphate, bismelamine zincodiphosphate (EP 2 609 173 A1) and/or bismelamine aluminotriphosphate (EP 2 609 173 A1), very particular preference being given to melamine polyphosphate and/or melamine cyanurate. Melamine polyphosphate [CAS No. 218768-84-4] is available commercially in diverse product grades. Examples of this include Melapur® 200/70 from BASF, Ludwigshafen, Germany, and also Budit® 3141 from Budenheim, Budenheim, Germany. Melamine cyanurate [CAS No. 37640-57-6] is available commercially in diverse product grades. Examples of this include Melapur® MC25 from BASF, Ludwigshafen, Germany.

Component E)

In a further preferred embodiment, the compositions and the moulding compounds and products to be produced therefrom further comprise, in addition to components A) to D) or Instead of D), E) at least one filler or reinforcing agent, preferably of about 0.1 to about 50 wt %, more preferably about 3 to about 40 wt %, very preferably about 10 to about 30 wt %, and at least one of the components A), B), C) and D) or A), B) and C) is to be varied within the quantitative ranges specified in such a way that the sum of all the weight percentages of components A), B), C), D) and E) or A), B), C) and E), respectively, based on the moulding compound, is always 100.

It is nevertheless preferred for a mixture of two or more different fillers and/or reinforcing agents, based in particular on mica, silicate, quartz, more particularly finely ground quartz, titanium dioxide, wollastonite, kaolin, amorphous silicas, magnesium carbonate, chalk, feldspar, barium sulphate, glass fibres, glass beads, finely ground glass and/or fibrous fillers and/or reinforcing agents based on carbon fibres to be used as component E). Preference is given to using particulate mineral fillers based on mica, silicate, quartz, wollastonite, kaolin, amorphous silicas, magnesium carbonate, chalk or feldspar. Particular preference is additionally also given to using acicular mineral fillers as an additive. Acicular mineral reinforcing agents, also referred to as fillers, are understood in accordance with the invention to comprise a mineral filer having strongly pronounced acicular character. The mineral preferably has a length diameter ratio of about 2:1 to about 35:1, more preferably about 3:1 to about 19:1, most preferably about 4:1 to about 12:1. The median particle size d50 of the acicular minerals for use in accordance with the invention is preferably less than about 20 μm, more preferably less than about 15 μm, especially preferably less than about 10 μm, determined with a CILAS GRANULOMETER in analogy to ISO 13320:2009 by means of laser diffraction.

As a result of their processing to the moulding compound or to a product, all fillers and/or reinforcing agents that can be used as component E) may have a smaller d97 or d50 within these moulding compounds or products than the fillers and/or reinforcing agents and/or glass fibres originally employed.

Regarding the d50 and d97 values in this specification, and their determination and their significance, reference may be made to Chemie Ingenieur Technik (72) pp. 273-276, March 2000, Wiley-VCH Verlags GmbH, Weinheim, 2000, whereby the d50 is the particle size below which 50% of the particle quantity is situated (median), and the d97 is the particle size below which 97% of the particle quantity is situated.

The statements of particle size distribution or of particle sizes in the context of the present invention refer to what are called surface-based particle sizes, in each case prior to incorporation into the thermoplastic moulding compound. Particle size determination takes place by laser diffractometry, see C. M. Keck, Moderne Pharmazeutische Technologie 2009, Freie Universität Berlin, section 3.1, or QUANTACHROME PARTIKELWELT NO 6, June 2007, pages 1 to 16. The underlying standard is ISO 13317-3.

The fillers and reinforcing agents can be used individually or as a mixture of two or more different fillers and/or reinforcing agents.

The filler and/or reinforcing agent to be used as component E) may in one preferred embodiment be surface-modified, more preferably with an adhesion promoter or adhesion promoter system, especially preferably an epoxide-based one. However, the pretreatment is not absolutely necessary.

In one particularly preferred embodiment, glass fibres are used as component E). According to “http://de.wikipedia.org/wiki/Faser-Kunststoff-Verbund”, a distinction is made between chopped fibres, also called short fibres, having a length of 0.1 to 1 mm, long fibres, having a length of 1 to 50 mm, and continuous fibres, having a length L>about 50 mm. Short fibres are used in injection moulding technology and can be processed directly with an extruder. Long fibres can likewise still be processed in extruders. They are widely used in spray lay-up. Long fibres are frequently added to thermosets as a filler. Continuous fibres are used in the form of rovings or fabric in fibre-reinforced plastics. Products comprising continuous fibres achieve the highest stiffness and strength values. Further available are ground glass fibres, the length of these after grinding typically being about 70 to about 200 μm.

According to the invention, chopped long glass fibres having an initial length of about 1 to about 50 mm, more preferably about 1 to about 10 mm and very preferably about 2 to about 7 mm are used with preference as component E). In the moulding compound or in the product, the glass fibres for use with preference as component E) may have a smaller d97 and/or d50 than the glass fibres originally employed, as a result of processing to the moulding compound or to the product. Thus, the arithmetic mean of the glass fibre length after processing is frequently only about 150 μm to about 300 μm.

The glass fibre length and glass fibre length distribution are determined in the context of the present invention, in the case of processed glass fibres, in analogy to ISO 22314, which first stipulates ashing of the samples at 825° C. Subsequently, the ash is placed onto a microscope slide covered with demineralized water in a suitable crystallizing dish, and the ash is distributed in an ultrasound bath with no action of mechanical forces. The next step involves drying in an oven at 130° C., followed by the determination of the glass fibre length with the aid of light microscopy images. For this purpose, at least 100 glass fibres are measured in three images, and so a total of 300 glass fibres are used to ascertain the length. The glass fibre length either can be calculated as the arithmetic mean lₙ according to the equation

$${l}_{n} = \frac{1}{n} \cdot {\sum }_{i}^{n} {l}_{i}$$

where lₗ=length of the ith fibre and n=number of fibres measured, and represented appropriately as a histogram, or else, in the case of an assumed normal distribution of the measured glass fibre lengths l, it can be determined by means of the Gaussian function in accordance with the equation

$$f ( l ) = \frac{1}{\sqrt{2 π} \cdot σ} \cdot {e}^{- \frac{1}{2} \cdot {( \frac{l - {l}_{c}}{σ} )}^{2}} .$$

In this equation, l_{C} and σ are specific parameters of the normal distribution: l_{C} is the mean and a is the standard deviation (see: M. SchoBig, Schädigungsmechanismen in faserverstärkten Kunststoffen, 1, 2011, Vieweg und Teubner Verlag, page 35, ISBN 978-3-8348-1483-8). Glass fibres not incorporated into a polymer matrix are analysed with respect to their lengths by the above methods, but without processing by ashing and separation from the ash.

The glass fibres [CAS No. 65997-17-3] for use with preference in accordance with the invention as component E) preferably have a fibre diameter of about 7 to about 18 μm, more preferably about 9 to about 15 μm, which can be determined by at least one facility available to the skilled person, in particular by μ-Röntgen computer tomography in analogy to “Quantitative Messung von Faserlängen und-verteilung in faserverstärkten Kunststoffteilen mittels μ-Röntgen-Computertomographie” [Quantative measurement of fibre lengths end fibre distribution in fibre-reinforced plastic components by microroentgen computer tomography], J. KASTNER, et al. DGZfP-Jahrestagung 2007-paper 47. The glass fibres for preferred use as component E) are added preferably as continuous fibres or as chopped or ground glass fibres.

The fillers and/or reinforcing agents for use as component E), more particularly glass fibres, are preferably equipped with a suitable size system and with an adhesion promoter or adhesion promoter system, more preferably a silane-based one.

Especially preferred silane-based adhesion promoters for pretreatment are silane compounds of the general formula (IV)

(X—(CH₂)_{q})ₖ—Si—(O—CᵣH₂ᵣ₊₁)₄₋ₖ (IV)

in which the substituents are defined as follows:

X: NH₂—, H₂—,

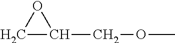

q: an integer from 2 to 10, preferably 3 to 4,

r: an integer from 1 to 5, preferably 1 to 2,

k: an integer from 1 to 3, preferably 1.

Especially preferred adhesion promoters are silane compounds from the group of aminopropyltrimethoxysilane, aminobutyltrimethoxysilane, aminopropyttriethoxysilane, aminobutyltriethoxysilane, and the corresponding slianes containing a glycidyl group as the X substituent.

For the equipping of the glass fibres, the silane compounds are used preferably in amounts of about 0.05 to about 2 wt %, more preferably about 0.25 to about 1.5 wt % and more particularly about 0.5 to about 1 wt %, based on the filler and/or reinforcing agent, more particularly the glass fibres, for the surface coating.

Component F)

In a further preferred embodiment, the compositions and/or moulding compounds and products based thereon, in addition to components A) to E) or instead of C) and/or D) and/or E), further comprise F) at least one further additive, which is different from components B), C), D) and E), preferably in an amount of about 0.01 to about 60 wt %, more preferably about 0.1 to about 50 wt %, very preferably about 0.2 to about 25 wt %, based in each case on the overall composition, and the sum of all the weight percentages of components A), B), C), D), E), F) or A), B), D), E), F) or A), B), C), E), F) or A), B), C), D), F) or A), B), E), F) or A), B), C), F) or A), B), D), F) or A), B), E), F) or A), B), F), based on the overall composition, is always 100.

Preferred further additives in the sense of the present invention are UV stabilizers, further flame retardants other than component D), heat stabilizers, lubricants and mould release agents, fillers and reinforcing agents, laser absorbers, additives with a functionality of two or more and a branching or chain-extending action, gamma-ray stabilizers, hydrolysis stabilizers, antistats, emulsifiers, plasticizers, processing aids, flow assistants, elastomer modifiers and colorants. The additives can be used in each case alone or in a mixture and/or in the form of masterbatches.

Lubricants and mould release agents are preferably those selected from the series of long-chain fatty acids, salts of long-chain fatty acids, ester derivatives of long-chain fatty acids, and montan waxes.

Preferred long-chain fatty acids are stearic acid or behenic acid. Preferred salts of long-chain fatty acids are Ca or Zn stearate. Preferred ester derivatives of long-chain fatty acids are those based on pentaerythritol, more particularly C₁₆-C₁₈ fatty acid esters of pentaerythritol [CAS No. 68604-44-4] or [CAS No. 85116-93-4].

Montan waxes in the sense of the present invention are mixtures of straight-chain, saturated carboxylic acids having chain lengths of about 28 to about 32 C atoms. Particularly preferred in accordance with the invention for use are lubricants and/or mould release agents from the group of the esters of saturated or unsaturated aliphatic carboxylic acids having about 8 to about 40 C atoms with aliphatic saturated alcohols having about 2 to about 40 C atoms, and also metal salts of saturated or unsaturated aliphatic carboxylic acids having about 8 to about 40 C atoms, very particular preference being given to pentaerythritol tetrastearate, calcium stearate [CAS No. 1592-23-0] and/or ethylene glycol dimontanate, here more particularly Licowax® E [CAS No. 74388-22-0] from Clariant, Muttenz, Basel, and especial preference being given to pentaerythritol tetrastearate [CAS No. 115-83-3], available, for example, as Loxiol® P861 from Emery Oleochemicals GmbH, Düsseldorf, Germany.

UV stabilizers used with preference are substituted resorcinols, salicylates, benzotriazoles, triazine derivatives or benzophenones.

Colorants used are preferably organic pigments, preferably phthalocyanines, quinacridones, perylenes and also dyes, preferably nigrosine or anthraquinones, and also inorganic pigments, especially titanium dioxide and/or barium sulphate, ultramarine blue, iron oxide, zinc sulphide or carbon black.

For the titanium dioxide for preferred use as pigment in accordance with the invention, suitable titanium dioxide pigments are those whose core structures can be produced by the sulphate (SP) or chloride (CP) process and have anatase and/or rutile structure, preferably rutile structure. The core structure need not have been stabilized, although a specific stabilization is preferred: in the case of the CP core structure, by Al doping of about 0.3-3.0 wt % (calculated as Al₂O₃) and an oxygen excess in the gas phase during the oxidation of the titanium tetrachloride to titanium dioxide of at least about 2%; in the case of the SP core structure, by doping, for example, with Al, Sb, Nb or Zn. Particular preference is given to “light” stabilization with Al, or in the case of higher amounts of Al doping to compensation with antimony. Where titanium dioxide is used as white pigment in paints and coatings, plastics and so on, it is known that unwanted photocatalytic reactions generated by UV absorption lead to the decomposition of the pigmented material. This involves absorption of light in the near ultraviolet range by titanium dioxide pigments, forming electron-hole pairs, which produce highly reactive free radicals on the titanium dioxide surface. The free radicals formed result in binder degradation in organic media. With preference in accordance with the invention, the photoactivity of the titanium dioxide is lowered by Inorganic aftertreatment thereof, more preferably with oxides of Si and/or Al and/or Zr and/or through the use of Sn compounds.

The surface of pigmentary titanium dioxide is covered preferably with amorphous precipitations of oxide hydrates of the compounds SiO₂ and/or Al₂O₃ and/or zirconium oxide. The Al₂O₃ shell facilitates pigment dispersion into the polymer matrix; the SiO₂ shell makes it more difficult for charge exchange to take place at the pigment surface, and so prevents polymer breakdown.

According to the invention, the titanium dioxide is preferably provided with hydrophilic and/or hydrophobic organic coatings, especially with siloxanes or polyalcohols.

Titanium dioxide [CAS No. 13463-67-7] for preferred use in accordance with the invention as a colorant of component F) preferably has an average particle size d50 of about 90 nm to about 2000 nm, more preferably about 200 nm to about 800 nm. The average particle size d50 is the value, determined from the particle size distribution, at which 50 wt % of the particles have an equivalent sphere diameter smaller than this d50 figure. The underlying standard is ISO 13317-3.

The statements of the particle size distribution and average particle size for titanium dioxide are based on so-called surface-based particle sizes, in each case before incorporation into the thermoplastic moulding compound. The particle size determination is made in accordance with the invention by laser diffractometry; see C. M. Keck, Moderne Pharmazeutische Technologie 2009, Freie Universität Berlin, section 3.1, or QUANTACHROME PARTIKELWELT NO 6, June 2007, pages 1 to 16.

Examples of commercially available titanium dioxide include Kronos® 2230, Kronos® 2233, Kronos® 2225 and Kronos® vlp 7000 from Kronos, Dallas, USA.

In accordance with the invention, the titanium dioxide for preferred use as pigment is used preferably in an amount of about 0.1 to about 15 wt %, more preferably about 0.5 to about 10 wt %, very preferably about 1 to about 5 wt %.

If not already used as a filler, it is possible in one particularly preferred embodiment for barium sulphate [CAS No. 7727-43-7] to be used as pigment. It can be used in the form of the naturally occurring baryte or in the form of barium sulphate produced synthetically by known technical processes, the preference being for synthetic variants. Customary preparation methods for barium sulphate taught in http://de.wikipedia.org/wiki/Bariumsulphat, for example, are the precipitation of barium sulphide or barium chloride with sodium sulphate. The average particle size [d50] in this case is preferably about 0.1 to about 50 μm, more preferably about 0.5 to about 10 μm and very preferably about 0.6 to about 2 μm. The barium sulphate here may be untreated or may have been equipped with organic and/or inorganic surface treatments.

Examples of inorganic or organic surface treatments and also methods for the application thereof to the surface are taught in WO2008/023074 A1, for example. Suitable barium sulphates are available, for example, from Sachtleben Chemie GmbH, Duisburg, Germany under the trade names Albasoft® 90, Albasoft® 100, and Blanc fixe F and Blanc Fixe Super F.

Barium sulphate for use as component F) is employed preferably in the quantitative range of about 0.1 to about 7 wt %, more preferably about 0.5 to about 5 wt %.

As component F) it is possible with preference to use additives, with a functionality of two or more that have branching or chain-extending activity and comprise at least two and not more than 15 functional groups with branching or chain-extending activity per molecule. Suitable branching or chain-extending additives include low molecular mass or oligomeric compounds which possess at least two and not more than 15 functional groups with branching or chain-extending activity per molecule, and which are able to react with primary and/or secondary amino groups, and/or amide groups and/or carboxylic acid groups. Functional groups with chain-extending activity are preferably isocyanates, alcohols, blocked isocyanates, epoxides, maleic anhydride, oxazolines, oxazines, oxazolones.

Especially preferred additives with a functionality of two or more and a branching or chain-extending activity are diepoxides based on diglycidyl ether (bisphenol and epichlorohydrin), based on amine epoxy resin (aniline and epichlorohydrin), based on diglycidyl ester (cycloaliphatic dicarboxylic acids and epichlorohydrin), individually or in mixtures, and also 2,2-bis[p-hydroxyphenyl]propane diglycidyl ether, bis[p-(N-methyl-N-2,3-epoxypropylamino)phenyl]methane, and also epoxidized fatty acid esters of glycerol, containing at least two and not more than 15 epoxide groups per molecule.

Particularly preferred additives with a functionality of two or more and a branching or chain-extending activity are glycidyl ethers, very preferably bisphenol A diglycidyl ether [CAS No. 98460-24-3] or epoxidized fatty acid esters of glycerol, and also, very preferably, epoxidized soya bean oil [CAS No. 8013-07-8].

The following, moreover, are particularly preferably suitable for branching/chain extension:

1. Poly- and/or oligoglycidyl or poly(3-methylglycidyl) ethers obtainable by reaction of a compound having at least two free alcoholic hydroxyl groups and/or phenolic hydroxyl groups and a suitably substituted epichlorohydrin under alkaline conditions, or in the presence of an acidic catalyst with subsequent alkali treatment.

Poly- and/or oligoglycidyl or poly(β-methylglycidyl) ethers derive preferably from acyclic alcohols, especially ethylene glycol, diethylene glycol and higher poly(oxyethylene) glycols, propane-1,2-diol, poly(oxypropylene) glycols, propane-1,3-diol, butane-1,4-diol, poly(oxotetramethylene) glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins.

They also derive preferably, however, from cycloaliphatic alcohols, especially 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they possess aromatic nuclei, especially N,N-bis(2-hydroxyethyl)aniline or p,p′-bis(2-hydroxyethylamino)diphenylmethane.

The epoxide compounds may also derive preferably from mononuclear phenols, more particularly from resorcinol or hydroquinone, or they are based on polynuclear phenols, more particularly on bis(4-hydroxyphenyl)methane, 2,2-bis(4-hydroxyphenyl)propane, 2,2-bis(3,5-dibromo-4-hydroxyphenyl)propane, 4,4′-dihydroxydiphenyl sulphone, or on condensation products of phenols with formaldehyde that are obtained under acidic conditions, especially phenol novolaks.

2. Poly- and/or oligo(N-glycidyl) compounds further obtainable by dehydrochlorination of the reaction products of epichlorohydrin with amines which comprise at least two amino hydrogen atoms. These amines are preferably aniline, toluidine, n-butylamine, bis(4-aminophenyl)methane, m-xylylenediamine or bis(4-methylaminophenyl)methane, but also N,N,O-triglycidyl-m-aminophenol or N,N,O-triglycidyl-p-aminophenol.

However, the poly(N-glycidyl) compounds also include, preferably, N,N′-diglycidyl derivatives of cycloalkylene ureas, more preferably ethylene urea or 1,3-propylene urea, and N,N′-diglycidyl derivatives of hydantoins, especially 5,5-dimethylhydantoin.

3. Poly- and/or oligo(S-glycidyl) compounds, especially di-S-glycidyl derivatives which derive from dithiols, preferably ethane-1,2-dithiol or bis(4-mercaptomethylphenyl) ether.

4. Epoxidized fatty acid esters of glycerol, especially epoxidized vegetable oils. They are obtained by epoxidation of the reactive olefin groups of triglycerides of unsaturated fatty acids. Epoxidized fatty acid esters of glycerol can be prepared starting from unsaturated fatty acid esters of glycerol, preferably from vegetable oils, and organic peroxycarboxylic acids (Prilezhaev reaction). Processes for the preparation of epoxidized vegetable oils are described for example in Smith, March, March's Advanced Organic Chemistry (5th edition, Wiley-Interscience, New York, 2001). Preferred epoxidized fatty acid esters of glycerol are vegetable oils. An epoxidized fatty acid ester of glycerol particularly preferred in accordance with the invention is epoxidized soya bean oil [CAS No. 8013-07-8].

Plasticizers for preferred use as component F) are dioctyl phthalate, dibenzyl phthalate, butyl benzyl phthalate, hydrocarbon oils or N-(n-butyl)benzenesulphonamide.

Flow assistants for preferred use as component F) are copolymers of at least one α-olefin with at least one methacrylic ester or acrylic ester of an aliphatic alcohol. Particularly preferred here are copolymers for which the α-olefin is constructed from ethene and/or propene and the methacrylic ester or acrylic ester comprises as its alcohol component linear or branched alkyl groups having about 6 to about 20 C atoms. Very particular preference is given to 2-ethylhexyl acrylate. Copolymers suitable as flow assistants in accordance with the invention are notable not only for the composition but also for the low molecular weight. Accordingly, preference is given in particular to copolymers having an MFI as measured at 190° C. under a load of 2.16 kg of at least about 100 g/10 min, preferably of at least about 150 g/10 min, more preferably of at least about 300 g/10 min. The MFI, melt flow index, serves to characterize the flow of a melt of a thermoplastic and is subject to the standards ISO 1133 or ASTM D 1238. The MFI, and all figures relating to MFI in the context of the present invention, relate or were measured or determined in a standard manner to ISO 1133 at 190° C. with a test weight of 2.16 kg.

Elastomer modifiers for preferred use as component F) include, among others, one or more graft polymers of
F.1 about 5 to about 95 wt %, preferably about 30 to about 90 wt %, of at least one vinyl monomer
F.2 about 95 to about 5 wt %, preferably about 70 to about 10 wt %, of one or more graft bases having glass transition temperatures <10° C., preferably <0° C., more preferably <−20° C.

The graft base F.2 generally has an average particle size (d50) of about 0.05 to about 10 μm, preferably about 0.1 to about 5 μm, more preferably about 0.2 to about 1 μm.

Monomers F.1 are preferably mixtures of
F.1.1 about 50 to about 99 wt % of vinylaromatics and/or ring-substituted vinylaromatics, especially styrene, α-methylstyrene, p-methylstyrene, p-chlorostyrene, and/or (C₁-C₈) alkyl esters of methacrylic acid, more particularly methyl methacrylate, ethyl methacrylate and
F.1.2 about 1 to about 50 wt % of vinyl cyanides, especially unsaturated nitriles such as acrylonitrile and methacrylonitrile, and/or (C₁-C₈) alkyl esters of (meth)acrylic acid, especially methyl methacrylate, glycidyl methacrylate, n-butyl acrylate, tert-butyl acrylate, and/or derivatives, especially anhydrides and imides of unsaturated carboxylic acids, especially maleic anhydride or N-phenylmaleimide.

Preferred monomers F.1.1 are selected from at least one of the monomers styrene, a-methylstyrene and methyl methacrylate; preferred monomers F.1.2 are selected from at least one of the monomers acrylonitrile, maleic anhydride, glycidyl methacrylate and methyl methacrylate.

Particularly preferred monomers are styrene as F.1.1 and acrylonitrile as F.1.2.

Examples of graft bases F.2 suitable for the graft polymers for use in the elastomer modifiers are diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft bases F.2 are diene rubbers, especially based on butadiene, isoprene, etc., or mixtures of diene rubbers or copolymers of diene rubbers or mixtures thereof with further copolymerizable monomers, especially as per F.1.1 and F.1.2, with the proviso that the glass transition temperature of component F.2 is <10° C., preferably <0° C., more preferably <−10° C.

Particularly preferred graft bases F.2 are ABS polymers (emulsion-, bulk- and suspension-ABS), where ABS stands for acrylonitrile-butadiene-styrene, as described for example in DE-A 2 035 390 (=U.S. Pat. No. 3,644,574) or in DE-A 2 248 242 (=GB-A 1 409 275) or in Ullmann, Enzyklopädie der Technischen Chemie, vol. 19 (1980), p. 280 ff. The gel fraction of the graft base F.2 is preferably at least about 30 wt %, more preferably at least about 40 wt % (measured in toluene).

The elastomer modifiers or graft polymers are prepared by free-radical polymerization, preferably by emulsion, suspension, solution or bulk polymerization, especially by emulsion or bulk polymerization.

Particularly suitable graft rubbers are also ABS polymers, which are prepared by redox initiation with an initiator system composed of organic hydroperoxide and ascorbic acid according to U.S. Pat. No. 4,937,285.

Since, as is well known, the graft monomers are not necessarily grafted completely onto the graft base in the grafting reaction, according to the invention, graft polymers are also understood to mean those products which are obtained through (co)polymerization of the graft monomers in the presence of the graft base and occur in the workup as well.

Likewise suitable acrylate rubbers are based on graft bases F.2 which are preferably polymers of acrylic acid alkyl esters, optionally with up to about 40 wt %, based on F.2, of other polymerizable, ethylenically unsaturated monomers. The preferred polymerizable acrylic esters include C₁-C₈ alkyl esters, preferably methyl, ethyl, butyl, n-octyl and 2-ethylhexyl esters; haloalkyl esters, preferably halo-C₁-C₈ alkyl esters, preferably chloroethyl acrylate, glycidyl esters, and mixtures of these monomers. Particularly preferred in this context are graft polymers with butyl acrylate as core and methyl methacrylates as shell, more particularly Paraloid® EXL2300, Dow Corning Corporation, Midland Mich., USA.

Further graft bases as per F.2 of preferential suitability are silicone rubbers having graft-active sites, as described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515).

Preferred graft polymers with a silicone fraction are those which have methyl methacrylate or styrene-acrylonitrile as shell and a silicone/acrylate graft as core. Those with styrene-acrylonitrile as shell that can be used include Metablen® SRK200, for example. Those with methyl methacrylate as shell that can be used include Metablen® S2001, Metablen® S2030 and/or Metablen® SX-005, for example. Particularly preferred for use is Metablen® S2001. The products with the trade names Metablen® are available from Mitsubishi Rayon Co., Ltd., Tokyo, Japan.

For crosslinking, it is possible to copolymerize monomers having more than one polymerizable double bond. Preferred examples of crosslinking monomers are esters of unsaturated monocarboxylic acids having 3 to 8 carbon atoms and unsaturated monohydric alcohols having about 3 to about 12 carbon atoms or of saturated polyols having about 2 to about 4 OH groups and about 2 to about 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes; but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably about 0.02 to about 5 wt %, more particularly about 0.05 to about 2 wt %, based on the graft base F.2.

In the case of cyclic crosslinking monomers having at least three ethylenically unsaturated groups, it is advantageous to limit the amount to below about 1 wt % of the graft base F.2.

Preferred “other” polymerizable, ethylenically unsaturated monomers, which in addition to the acrylic esters may optionally serve for the preparation of the graft base F.2, are acrylonitrile, styrene, α-methylstyrene, acrylamides, vinyl C₁-C₆ alkyl ethers, methyl methacrylate, glycidyl methacrylate and butadiene. Preferred acrylate rubbers as graft base F.2 are emulsion polymers having a gel content of at least about 60 wt %.

Besides elastomer modifiers based on graft polymers, it is likewise possible to use elastomer modifiers not based on graft polymers, and having glass transition temperatures <10° C., preferably <0° C., more preferably <−20° C. These preferably include elastomers having a block copolymer structure, and additionally thermoplastically meltable elastomers, especially EPM, EPDM and/or SEBS rubbers (EPM=ethylene-propylene copolymer, EPDM=ethylene-propylene-diene rubber and SEBS=styrene-ethene-butene-styrene copolymer).

Flame retardants for preferred use as component F) are phosphorus-containing compounds different from components B) and C) and for selection from the group of mono- and oligomeric phosphoric and phosphonic esters, phosphonate amines, phosphonates, especially aluminium phosphonates, triphosphates, especially aluminium dihydrogentriphosphate, phosphites, hypophosphites, phosphine oxides and phosphazenes. Particularly preferred are phenoxyphosphazene oligomers. The phosphazenes and their preparation are described for example in EP-A 728 811, DE-A 1961668 and WO-A 97/40092. Used with particular preference in accordance with the invention are cyclic phenoxyphosphazenes such as 2,2,4,4,6,6-hexahydro-2,2,4,4,6,6-hexaphenoxytriazatriphosphorine [CAS No. 1184-10-7] and/or those as obtainable, for example, from Fushimi Pharmaceutical Co. Ltd, Kagawa, Japan under the designation Rabitle® FP110 [CAS No. 1203646-63-2].

It is also possible to use nitrogen-containing flame retardants different from component D), individually or in a mixture, as flame retardants of component F). Preferred are guanidine salts, especially guanidine carbonate, primary guanidine cyanurate, primary guanidine phosphate, secondary guanidine phosphate, primary guanidine sulphate, secondary guanidine sulphate, guanidine pentaerythrityl borate, guanidine neopentyl glycol borate, urea phosphate and urea cyanurate. It is possible, furthermore, for reaction products of melem, melam and melon with condensed phosphoric acids to be used. Likewise suitable are tris(hydroxyethyl)isocyanurate or its reaction products with carboxylic acids, benzoguanamine and its adducts and/or salts, and also products thereof that are substituted on the nitrogen, and also the salts and adducts of these. Further nitrogen-containing components suitable include allantoin compounds, and also salts thereof with phosphoric acid, boric acid or pyrophosphoric acid, and also glycolurils or salts thereof. Other preferred nitrogen-containing flame retardants different from component D) are the reaction products of trichlorotriazine, piperazine and morpholine as per CAS No. 1078142-02-5, especially MCA PPM Triazin HF from MCA Technologies GmbH, Biel-Benken, Switzerland.

Other flame retardants or flame retardant synergists not specifically mentioned here can also be employed as component F). These include, among others, purely inorganic phosphorus compounds different from component C), more particularly red phosphorus or boron phosphate hydrate. It is also possible, furthermore, to use mineral flame retardant additives or salts of aliphatic and aromatic sulphonic acids, especially metal salts of 1-perfluorobutanesulphonic acid. Additionally suitable are flame retardant synergists from the group of the oxygen-, nitrogen- or sulphur-containing metal compounds wherein metal is zinc, molybdenum, calcium, titanium, magnesium or boron, preferably zinc oxide, zinc borate, zinc stannate, zinc hydroxystannate, zinc sulphide, molybdenum oxide, and, if not already used as colorant, titanium dioxide, magnesium carbonate, calcium carbonate, calcium oxide, titanium nitride, boron nitride, magnesium nitride, zinc nitride, calcium borate, magnesium borate or mixtures thereof.

Further flame retardant additives that are suitable and are for preferred use as component F) are char formers, more preferably poly(2,6-diphenyl-1,4-phenyl) ether, especially poly(2,6-dimethyl-1,4-phenylene) ether [CAS No. 25134-01-4], phenol-formaldehyde resins, polycarbonates, polyimides, polysulphones, polyethersulphones or polyether ketones, and also antidrip agents, especially tetrafluoroethylene polymers. The tetrafluoroethylene polymers can be used in pure form or else in combination with other resins, preferably styrene-acrylonitrile (SAN), or acrylates, preferably methyl methacrylate and/or butyl acrylate. An example with especially preferred suitability of tetrafluoroethylene-styrene-acrylonitrile resins is e.g. Cycolac® INP 449 [CAS No. 1427364-85-9] from Sabic Corp., Riad, Saudi Arabia; an example of especially preferred suitability of tetrafluoroethylene-acrylate resins is e.g. Metablen A3800 [CAS No. 639808-21-2] from Mitsubishi Rayon Co., Ltd., Tokyo, Japan. Antidrip agents comprising tetrafluoroethylene polymers are used in accordance with the invention as component F) preferably in amounts of about 0.01 to about 1 wt %, more preferably about 0.1 to about 0.6 wt %.

The flame retardants for additional use as component F) can be added in pure form, and also via masterbatches or compacted preparations, to the polyalkylene terephthalate or polycycloalkylene terephthalate.

Heat stabilizers for preferred use as component F) are selected from the group of sulphur-containing stabilizers, especially sulphides, dialkylthiocarbamates or thiodipropionic acids, and also those selected from the group of the iron salts and the copper salts, in the latter case especially copper(I) iodide, being used preferably in combination with potassium iodide and/or sodium hypophosphite NaH₂PO₂, and also sterically hindered amines, especially tetramethylpiperidine derivatives, aromatic secondary amines, especially diphenylamines, hydroquinones, substituted resorcinols, salicylates, benzotriazoles and benzophenones, and also sterically hindered phenols and aliphatically or aromatically substituted phosphites, and also differently substituted representatives of these groups.

Preferred among the sterically hindered phenols for use are those having at least one 3-tert-butyl-4-hydroxy-5-methylphenyl building block and/or at least one 3,5-di(tert-butyl-4-hydroxyphenyl) building block, particular preference being given to 1,6-hexanediol bis[3-(3,5-di-tert-butyl-4-hydroxyphenyl)propionate][CAS No. 35074-77-2] (Irganox® 259 from BASF SE, Ludwigshafen, Germany), pentaerythritol tetrakis[3-(3,5-di-tert-butyl-4-hydroxyphenyl)propionate][CAS No. 6683-19-8] (Irganox® 1010 from BASF SE) and 3,9-bis[2-[3-(3-tert-butyl-4-hydroxy-5-methylphenyl)proponyloxy]-1,1-dimethylethyl]-2,4,8,10-tetraoxaspiro[5.5]undecane [CAS No. 90498-90-1] (ADK Stab® AO 80). ADK Stab® AO 80 is a commercial product from Adeka-Palmerole SAS, Mulhouse, France.

Among the aliphatically or aromatically substituted phosphites for use, preference is given to bis(2,4-dicumylphenyl)pentaerythritol diphosphite [CAS No. 154862-43-8], which is available for example from Dover Chemical Corp., Dover, USA under the trade name Doverphos® S9228, and tetrakis(2,4-di-tert-butylphenyl)-1,1-biphenyl-4,4′-diyl bisphosphonite [CAS No. 38613-77-3], which can be obtained, for example, as Hostanox® P-EPQ from Clariant International Ltd., Muttenz, Switzerland.

In a preferred embodiment, the present invention relates to compositions and moulding compounds producible therefrom and also products comprising A) polybutylene terephthalate, B) aluminium trisdiethylphosphinate and as C) zinc bis(dihydrogenphosphate).

In a preferred embodiment, the present invention also relates to compositions and moulding compounds producible therefrom and also products comprising A) polybutylene terephthalate, B) aluminium trisdiethylphosphinate and as C) zinc bis(dihydrogenphosphate) dihydrate.

In a preferred embodiment, the present invention also relates to compositions and moulding compounds producible therefrom and also products comprising A) polybutylene terephthalate, B) aluminium trisdiethylphosphinate and as C) zinc pyrophosphate.

In a preferred embodiment, the present invention also relates to compositions and moulding compounds producible therefrom and also products comprising A) polybutylene terephthalate, B) aluminium trisdiethylphosphinate, as C) zinc bis(dihydrogenphosphate) dihydrate and D) melamine cyanurate.

In a preferred embodiment, the present invention also relates to compositions and moulding compounds producible therefrom and also products comprising A) polybutylene terephthalate, B) aluminium trisdiethylphosphinate, as C) zinc bis(dihydrogenphosphate) dihydrate, D) melamine cyanurate and E) glass fibres.

In another embodiment the present invention refers to compositions and to mouldings wherein 100 parts by weight of component A) are combined with component B), about 5 to about 50 parts by weight, and component C), about 0.001 to about 4 parts by weight.

Use

The present invention, however, also relates to the use of the compositions of the invention, especially in the form of moulding compounds, for producing tracking-resistant products, especially electrical or electronic assemblies and components.

The present invention, however, also relates to the use of the compositions of the invention for boosting the tracking resistance of polyester-based products, preferably of products of the electrical or electronics industry, more particularly products of the electrical or electronics industry where the polyester used is at least one polyalkylene terephthalate and/or at least one polycycloalkylene terephthalate, in particular at least polybutylene terephthalate.

Method

The present invention, however, also relates to a method for producing products, preferably for the electrical or electronics industry, more preferably electronic or electrical assemblies and components, by mixing compositions of the invention to form a moulding compound. These moulding compounds may additionally be discharged in the form of a strand, cooled until pelletizable and pelletized, before being subjected as a matrix material to injection moulding or extrusion, preferably injection moulding.

Preference is given to mixing at temperatures of about 240 to about 310° C., preferably about 260 to about 300° C., more preferably about 270 to about 295° C., in the melt. Especially preferably, a twin-screw extruder is used for this purpose.

In one embodiment, the pellets comprising the composition of the invention are dried, preferably at temperatures of around 120° C. in a vacuum drying cabinet or in a dry air drier, for a duration in the region of about 2 hours, before being subjected, as matrix material, to injection moulding or an extrusion process in order to produce products according to the invention.

The present invention, however, also relates to a method for improving the tracking resistance of polyester-based products, by processing compositions of the invention in the form of moulding compounds as matrix material by injection moulding or extrusion and using as polyester at least one polyalkylene terephthalate and/or at least one polycycloalkylene terephthalate, more particularly at least polybutylene terephthalate.

The processes of injection moulding and of extrusion of thermoplastic moulding compounds are known to those skilled in the art.

Methods according to the invention for producing polyester-based products by extrusion or injection moulding operate at melt temperatures of about 240 to about 330° C., preferably about 260 to about 300° C., more preferably about 270 to about 290° C., and also, optionally, at pressures of not more than about 2500 bar, as well, preferably at pressures of not more than about 2000 bar, more preferably at pressures of not more than about 1500 bar and very preferably at pressures of not more than about 750 bar.

Sequential coextrusion involves expelling two different materials successively in alternating sequence. In this way, a preform having a different material composition section by section in the extrusion direction is formed. Particular sections of articles can be equipped with specifically required properties by means of corresponding selection of material, as for example for articles having soft ends and a hard middle part, or having integrated soft bellows regions (Thielen, Hartwig, Gust, “Blasformen von Kunststolfhohikörpem”, Carl Hanser Verlag, Munich 2006, pages 127-129).

A feature of the process of injection moulding is that a moulding compound comprising the compositions of the invention, preferably in pellet form, is melted in a heated cylindrical cavity (i.e. is plasticized) and is injected as an injection compound under pressure into a heated cavity. After the cooling (solidification) of the material, the injection moulding is demoulded.

The following phases are distinguished:

1. Plastification/melting

2. Injection phase (filing operation)

3. Hold pressure phase (owing to thermal contraction in the course of crystallization)

4. Demoulding.

In this regard, see http://de.wikipedia.org/wiki/Spritzgie%C3%gFen. An injection moulding machine consists of a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mould, the incoming melt is then separated and cooled, and hence the product to be produced is produced. Two halves of the mould are always needed for this purpose. In injection moulding, the following functional systems are distinguished:
runner system
shaping inserts
venting
machine casing and force absorber
demoulding system and movement transmission
heating

In contrast to injection moulding, extrusion uses a continuously shaped polymeric strand of a moulding compound of the invention in the extruder, the extruder being a machine for producing shaped thermoplastic pieces. Reference here may be made to http://de.wikipedia.org/wiki/Extrusionsblasformen. A distinction is made between single-screw extruders and twin-screw extruders, and also the respective sub-groups of conventional single-screw extruders, conveying single-screw extruders, contra-rotating twin-screw extruders and co-rotating twin-screw extruders.

Extrusion systems consist of extruder, mould, downstream equipment, extrusion blow moulds. Extrusion systems for production of profiles consist of: extruder, profile mould, calibration, cooling zone, caterpillar take-off and roll take-off, separating device and tilting chute.

The present invention, accordingly, also relates to products, especially tracking-resistant products, obtainable by extrusion, preferably profile extrusion, or injection moulding of the moulding compounds obtainable from the compositions of the invention.

It will be understood that the specification and examples are illustrative but not limitative of the present invention and that other embodiments within the spirit and scope of the invention will suggest themselves to those skilled in the art.

### EXAMPLES

In order to demonstrate the inventively described improvements in tracking resistance and mechanical properties, corresponding polyester moulding compounds were first of all prepared by compounding. The individual components were for this purpose mixed in a twin-screw extruder (ZSK 32 Mega Compounder from Coperion Wemer & Pfleiderer (Stuttgart, Germany)) at temperatures of from 260 to 300° C., discharged as a strand, cooled until pelletizable and pelletized. After drying (generally 2 hours at 120° C. in a vacuum drying cabinet), the pellets were processed to form test specimens.

The test specimens for the investigations listed in Table 2 were moulded on an Arburg 320-210-500 injection moulding machine at a melt temperature of 260° C. and a mould temperature of 80° C.:
test rods 80 mm*10 mm 4 mm (as per ISO 178 or ISO180/1U)
ASTM-standard test specimens for UL94V testing
test specimens for glow wire testing to DIN EN 60695-2-13
test specimens for measurement of tracking resistance to IEC60112

The flexural strength and the outer fibre strain were obtained from flexural tests in accordance with ISO178 on test specimens with dimensions of 80 mm*10 mm*4 mm.

The impact resistance was obtained by the IZOD method in accordance with ISO180-1U on test specimens with dimensions of 80 mm*10 mm*4 mm.

The flame retardancy was determined by the UL94V method (Underwriters Laboratories Inc. Standard of Safety, “Test for Flammability of Plastic Materials for Parts in Devices and Appliances”, p. 14 to p. 18 Northbrook 1998). The dimensions of the test specimens were 125 mm*13 mm*0.75 mm.

The glow wire resistance was determined on the basis of the GWIT (Glow Wire Ignition Temperature) test to DIN EN 60695-2-13. In the context of the GWIT test, the figure reported is the glow wire ignition temperature which is 25K (or 30K in the case of temperatures from 900° C. to 960° C.) higher than the maximum glow wire temperature which fails to result in ignition in three successive tests, even during the time of exposure to the glow wire. Ignition here is taken to be a flame with a burn time ≧5 seconds. For the tests, circular plates with a diameter of 80 mm and a thickness of 0.75 mm were used.

The comparative tracking index (or tracking resistance) was determined in accordance with IEC 60112 on test specimens with dimensions of 60 mm*40 mm*4 mm.

The melt viscosity was determined in the form of the melt volume-flow rate (MVR) in accordance with ISO1133-1 in each case at a temperature of 260° C. and 280° C. with an applied weight of 2.16 kg on the pellets in each case, the composition in each case being held for a residence time of 5 minutes for the purpose of assessing the temperature stability. Given comparable initial viscosity of the polymer used, the MVR is a measure of the degradation of the polymer as a result of thermal loading. A high figure for the MVR represents a low melt viscosity and hence a greater thermal degradation.

The following were used in the experiments:

Component A): Linear polybutylene terephthalate (Pocan® B 1300, commercial product of Lanxess Deutschland GmbH, Leverkusen, Germany) having an intrinsic viscosity of 93 cm³/g (measured in phenol: 1,2-dichlorobenzene=1:1 at 25° C.)

Component B): Aluminium tris(diethylphosphinate), [CAS No. 225789-38-8] (Exolit® OP1230 from Clariant SE, Muttenz, Switzerland)

Component C): Zinc bis[dihydrogenphosphate]dihydrate [CAS No. 13986-21-5] (Z21-82 from Chemische Fabrik Budenheim KG, Budenheim, Germany)

Component D): Melamine cyanurate, (Melapur® MC25, from BASF SE, Ludwigshafen, Germany)

Component E): glass fibres having a diameter of 10 μm, sized with silane-containing compounds (CS 7967, commercial product from Lanxess N.V., Antwerp, Belgium)

Component F1): Barium sulphate [CAS No. 7727-43-7] (BLANC FIXE Super F from Sachtleben Chemie GmbH, Duisburg, Germany)

Further component F) additives used in the examples were, as component F2), the following components customary for use in flame-retardant thermoplastic polyesters:

Mould release agent: Pentaerythrityl tetrastearate (PETS) [CAS No. 115-83-3] (Loxiol® VPG 861, from Cognis Deutschland GmbH, Düsseldorf, Germany)

Heat stabilizer Tetrakis(2,4-di-tert-butylphenyl)-1,1-biphenyl-4,4′-diyl bisphosphonite [CAS No. 38613-77-3] (Hostanox® P-EPQ from Clariant International Ltd., Muttenz, Switzerland)

Antidripping additive: Polytetrafluoroethylene, [CAS No. 9002-84-0] (Dyneon® PA 5932 from Dyneon GmbH & Co KG, Neuss, Germany)

The further additives used (component F2)) match in nature and amount in each case for corresponding inventive and comparative examples, specifically with F2)=0.7 wt %.

The sum of the fractions of the components adds up in each case to 100 wt %.

TABLE 1
(all amounts in wt %)

| | | | Comparative |
|---|---|---|---|
| | Example 1 | Example 2 | example |
| A) | 51 | 49.5 | 51.3 |
| B) | 16.5 | 16.5 | 16.5 |
| C) | 0.3 | 0.3 | — |
| D) | 6.5 | 6.5 | 6.5 |
| E) | 25 | 25 | 25 |
| F1) | | 1.5 | |
| F2) | 0.7 | 0.7 | 0.7 |

TABLE 2

| | | | | Comparative |
|---|---|---|---|---|
| | Unit | Example 1 | Example 2 | Example |
| IZOD | [kJ/m²] | 30 | 27 | 23 |
| Flexural strength | [MPa] | 145 | 141 | 135 |
| Outer fibre strain | [%] | 2.4 | 2.3 | 2 |
| Tracking resistance | [V] | 575 | 600 | 550 |
| MVR 280° C./2.16 kg | [cm³/10 | 13.9 | 15 | 29.7 |
| | min] | | | |
| MVR 260° C./2.16 kg | [cm³/10 | 6.9 | 6.7 | 14.4 |
| | min] | | | |
| GWIT | [° C.] | >775 | >775 | 775 |
| UL94 | [Class] | V-0 | V-0 | V-0 |

The examples show that when component C) is used, relative to the comparison without component C), an improvement can be achieved in the tracking resistance and in the mechanical properties. The improvement in the mechanical properties is evident both in the increased impact resistance and in the improvement in outer fibre strain and flexural strength. The improved mechanical properties can also be seen in connection with the much smaller MVR values relative to the comparative example without component C), which point to a lower level of polymer degradation. All improvements are unaccompanied by any negative effect on flame retardancy.

What is claimed is:

1. A composition comprising
A) at least one polyalkylene terephthalate or polycycloalkylene terephthalate,
B) at least one organic phosphinic salt of the formula (I) and/or at least one organic diphosphinic salt of the formula (II) and/or polymers thereof, 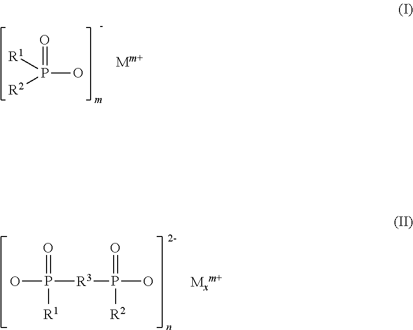
in which
R¹ and R² are identical or different and are a linear or branched C₁-C₆ alkyl, and/or are C₅-C₁₄ aryl,
R³ is linear or branched C₁-C₁₀ alkylene, C₅-C₁₀ arylene or C₁-C₆ alkyl-C₆-C₁₀ arylene or C₆-C₁₀ aryl-C₁-C₆ alkylene,
M is aluminium, zinc or titanium,
m is an integer from 1 to 4;
n is an integer from 1 to 3, and
x is 1 and 2,
and n, x and m in formula (II) may at the same time adopt only those integers such that the diphosphinic salt of the formula (II) as a whole is uncharged, and
C) at least one inorganic phosphate salt from the group of metal hydrogen phosphates, metal dihydrogen phosphates, metal dihydrogen pyrophosphates and/or metal pyrophosphates, wherein the metal is from the group of sodium, potassium, magnesium, zinc, copper and/or aluminium.

2. The composition according to claim 1, further comprising at least one nitrogen-containing flame retardant component D).

3. The composition according to claim 1, further comprising at least one of:
at least one nitrogen-containing flame retardant component D); and
at least one filler or reinforcing agent E).

4. The composition according to claim 1, further comprising at least one of:
at least one nitrogen-containing flame retardant component D);
at least one filler or reinforcing agent E); and
at least one further additive F) which is different from components B), C), D) and E).

5. The composition according to claim 4, wherein F) is titanium dioxide.

6. The composition according to claim 1, wherein the metal in component C) is magnesium and/or zinc.

7. The composition according to claim 6, wherein the metal is zinc.

8. The composition according to claim 1, wherein component A) is a polyalkylene terephthalate selected from polyethylene terephthalate, polybutylene terephthalate or poly-1,4-cyclohexanedimethanol terephthalate.

9. The composition according to claim 1, wherein:
M in the formulae (I) or (II) is aluminium; and
R¹ and R² in the formulae (I) and (II) are identical or different and are C₁-C₅ alkyl, linear or branched, and/or phenyl.

10. The composition according to claim 4, wherein:
the component D) is melamine cyanurate, melamine polyphosphate, bismelamine zincodiphosphate, and/or bismelamine aluminotriphosphate;
the at least one filler or reinforcing agent E) is glass fibres; and
the at least one further additive F) is barium sulphate.

11. The composition according to claim 1, wherein
A) is polybutylene terephthalate,
B) is aluminium trisdiethylphosphinate; and
C) is zinc bis(dihydrogenphosphate).

12. The composition according to claim 1, wherein
A) is polybutylene terephthalate,
B) is aluminium trisdiethylphosphinate, and
C) is zinc bis(dihydrogenphosphate) dihydrate.

13. The composition according to claim 1, wherein
A) is polybutylene terephthalate,
B) is aluminium trisdiethylphosphinate, and
C) is zinc pyrophosphate.

14. The composition according to claim 1, wherein
A) is polybutylene terephthalate,
B) is aluminium trisdiethylphosphinate,
C) is zinc bis(dihydrogenphosphate) dehydrate, and
the composition further comprises D) melamine cyanurate.

15. The composition according to claim 1, wherein
A) is polybutylene terephthalate,
B) is aluminium trisdiethylphosphinate,
C) is zinc bis(dihydrogenphosphate) dihydrate, and
the composition further comprises:
D) melamine cyanurate, and
E) glass fibres.

16. The composition according to claim 1, wherein the composition comprises:
68 to 93.99 wt % of component A),
6 to 30 wt % of component B), and
0.01 to 2 wt % of component C),
wherein the sum of the weight percentages of A), B) and C) is 100%.

17. The composition according to claim 1, wherein 100 parts by weight of component A) are combined with 5 to 50 parts by weight of component B) and 0.001 to 4 parts by weight of component C).

18. A moulding composition obtained by mixing the compositions according to claim 1 in at least one mixer.

19. The moulding according to claim 16, wherein the mixer is a compounder, and the mixture is mixed in the compounder, formed into a strand, cooled until pelletizable and pelletized.

20. A flame retardant article of manufacture having tracking resistance, the article comprising an injection moulded or extruded moulding composition according to claim 19, and the article is at least one of an electrical assembly, an electronic assemblies and components.
